(19) United States
(12) Patent Application Publication
(10) Pub. No.: US 2026/0132584 A1
(43) Pub. Date: May 14, 2026

(54) VORTEX-INDUCED VIBRATION (VIV) SUPPRESSION APPARATUS AND METHOD OF INSTALLATION

(71) Applicant: J. RAY MCDERMOTT, S.A., Houston, TX (US)

(72) Inventors: Brian Michael KATTERHENRY, Houston, TX (US); Neil Sutherland HENDERSON, Houston, TX (US); Erich Thomas HEINEN, Houston, TX (US); Paul Anthony WATSON, Katy, TX (US); Gavin PARK, Houston, TX (US)

(21) Appl. No.: 19/118,498

(22) PCT Filed: Oct. 13, 2023
(86) PCT No.: PCT/US2023/035135

§ 371 Date: Apr. 4, 2025

Related U.S. Application Data
(60) Provisional application No. 63/415,886, filed on Oct. 13, 2022.
(60) Provisional application No. 63/415,889, filed on Oct. 13, 2022.

(51) Int. Cl. E02B 17/00

(52) U.S. Cl. CPC E02B 17/0017

(57) ABSTRACT

A method for installing a vortex-induced vibration (VIV)-suppression assembly includes introducing a ViV-suppression device or apparatus to a tubular member above a surface of a body of water such that the tubular member is at least partially enveloped, introducing the unsecured VIV-suppression device or apparatus around the tubular member into the body of water, positioning the unsecured VIV-suppression device or apparatus along the riser length of the tubular member, and securing the unsecured VIV-suppression device or apparatus along the riser length of the tubular member. A loaded VIV-suppression device spool comprises one or more VIV-suppression device or apparatus having a unitary length in a range of from 12 meters (m) to 6,000 meters, comprised of an elastic polymeric material, and wrapped around a hub of the spool in an extended, ribbon-like configuration under tension.

### BACKGROUND

### Field

Aspects of the present disclosure relate to systems, apparatuses, and methods associated with the installation and maintenance of tubular members within moving bodies of water.

### Description of the Related Art

A classic example of a tubular member is a pipe or open cylinder. A pipe has a cylindrical configuration with both an interior and an exterior-facing surfaces separated by a thickness of the body of the cylinder. A pipe has openings on opposing ends of the length of the cylinder that permits fluid to flow through an interior void, which the void is defined by the enclosing interior surface having a volume defined by the length of the cylinder and the cross-sectional area of the interior at given opposing points. Although tubular members may have many different configurations, such as shape, length, aspect ratios, interior volume, exterior surface area, thickness, and cross-sectional area, it is generally appreciated in the mechanical, chemical, and petrochemical arts that a “tubular member” is a tubiform where the ratio of its length is greater than its cross sectional area (for example, as defined by diameter or diagonal).

As an example, it is appreciated that, for example, a sub-sea oil and gas extraction platform may have several tubular members associated with its structure. Marine risers, which are pipelines used to not only import crude hydrocarbons extracted from the subsurface but also separately export initially-separated crude oil and natural gas, and tension legs, which are often metal tubulars (usually steel-based alloyed materials, although other metal materials, such as titanium or aluminum alloys, and polymer materials are also envisioned) that are held under tension to maintain the position of the extraction platform.

The use of tubular members in an aqueous environment, such as in an ocean, sea, gulf, lake, river, or marsh, where the fluid body has an active current or flow present may present significant operational and handling problems not only during introduction of the tubular member to the flowing fluid environment but also for the long-term use of the tubular member. Vortex-induced vibration (VIV) is a phenomenon that may be caused by a combination of various external and internal excitations based upon fluid moving around a solid object, such as a tubular member. When a fluid current flows past a tubular member, such as a riser, tendon, jumper, or a horizontal pipeline span, a repeating pattern of swirling vortices is created in the flowing water. When the vortices downflow of the tubular member (that is, on the backside of the tubular form relative to the fluid flowing around the form) do not form symmetrically around the tubular member or are not otherwise dispersed, differential lift forces develop on the trailing side of the body which, in time, become uneven and unstable. This uneven and unstable drag force pulls on the tubular member, leading to a shift in the position of the tubular member, which then changes the position of the lifting force, causing the tubular member to shift again. This repeated shifting back and forth along with the mass of the tubular member induces a periodic motion that is transverse to the current flow. This traverse motion by the tubular member is VIV, and the motion continues to build with time under continuous fluid flow. Stresses caused by VIV may cause tubular member material and weld fatigue, and eventually the tubular member may eventually fail at a joint due to the increasing and repeated oscillations. The force induced by the oscillation of a tubular member may also be translated to objects tied to the tubular member, such as subsurface equipment or surface vessels, leading to instability, damage, and potentially injury of personnel.

### SUMMARY

A method for installing a vortex-induced vibration (VIV)-suppression assembly may include introducing a VIV-suppression device or apparatus to a tubular member above a surface of a body of water such that the tubular member is at least partially enveloped. A portion of the tubular member is suspended above the surface of the body of water. A riser length potion of the tubular member is suspended in a vertical or near-vertical configuration below the surface of the water. The method may include introducing the unsecured VIV-suppression device or apparatus around the tubular member into the body of water. The method may include positioning the unsecured VIV-suppression device or apparatus along the riser length portion of the tubular member. The method may include securing the unsecured VIV-suppression device or apparatus along the riser length portion of the tubular member. The securing is such that at least a portion of the inner perimeter of the secured VIV-suppression device or apparatus contacts the outer perimeter of the tubular member, forming the VIV-suppression assembly.

A loaded VIV-suppression device spool may include one or more vortex-induced vibration (VIV)-suppression device or apparatus having a unitary length in a range of from 12 meters (m) to 6,000 meters. The VIV-suppression device or apparatus also comprises an elastic polymeric material. The VIV-suppression device or apparatus is wrapped around a hub of the spool in an extended, ribbon-like configuration under tension.

### BRIEF DESCRIPTION OF THE DRAWINGS

So that the manner in which the recited features of the present disclosure may be understood in detail, a more particular description of the disclosure may be had by reference to one or more embodiments, some of which are illustrated in the appended drawings. It is to be noted, however, that the appended drawings illustrate only one or more of the several embodiments; therefore, the one or more embodiments provided in the Drawings are not to be considered limiting of the broadest interpretation of the detailed scope. Other effective embodiments as may be described in the Detailed Description may be considered part of the envisioned detailed scope.

FIG. 1 is a schematic view of a marine environment where one or more embodiment VIV-suppression devices are represented as being or are in the process of being deployed on one or more tubular members, according to one or more embodiments.

FIG. 1A represents inset “A” of FIG. 1 showing an enhanced schematic view of a marine environment where a portion of an embodiment VIV-suppression device that is not secured is in the process of being deployed on one or more tubular members, according to one or more embodiments.

FIG. 1B represents inset “B” of FIG. 1 showing an enhanced schematic view of a marine environment where a portion of an embodiment VIV-suppression device that is not secured is in the process of being deployed on one or more tubular members, according to one or more embodiments.

FIG. 2 is a schematic of a VIV-suppression device in a sleeve-like strake configuration, according to one or more embodiments.

FIG. 2A shows a VIV-suppression device cross section view where the inner circumference or perimeter of the suppression apparatus IP(SA) is less than the outer permitted of the tubular member OP(TM), according to one or more embodiments.

FIG. 2B shows a VIV-suppression device cross section view where the inner circumference or perimeter of the suppression apparatus is equivalent to the outer permitted of the tubular member, according to one or more embodiments.

FIG. 2C shows a VIV-suppression device cross section view where the inner circumference or perimeter of the suppression apparatus is greater than the outer permitted of the tubular member, according to one or more embodiments.

FIG. 3 is a schematic of a VIV-suppression device in a sleeve-like fairing configuration, according to one or more embodiments.

FIG. 3A shows a VIV-suppression device cross section view where the inner perimeter of the suppression apparatus is less than the outer perimeter of the tubular member, according to one or more embodiments.

FIG. 3B shows a VIV-suppression device cross section view where the inner perimeter of the suppression apparatus is equivalent to the outer perimeter of the tubular member, according to one or more embodiments.

FIG. 3C shows a VIV-suppression device cross section view where the inner perimeter of the suppression apparatus is greater than the outer perimeter of the tubular member, according to one or more embodiments.

FIG. 4 is a schematic representation of an embodiment VIV-suppression device in different phases of configuration transition between a fully relaxed and contracted state and under tension and wrapped onto a loaded VIV-suppression device spool, according to one or more embodiments.

FIG. 4A is a schematic representing a partial cut-away view of a loaded VIV-suppression device spool, according to one or more embodiments.

FIG. 4B is a schematic representing a cross section view of a VIV-suppression device under tension, according to one or more embodiments.

FIG. 4C is a schematic representing a cross section view of a VIV-suppression device under transition between a state of tension and a state of relaxation, according to one or more embodiments.

FIG. 4D is a schematic representing a cross section view of a VIV-suppression device under relaxation, according to one or more embodiments.

FIG. 5 shows a process flow diagram for a method of forming a VIV-suppression assembly, according to one or more embodiments.

In this disclosure, the terms “top”, “bottom”, “side”, “above”, “below”, “up”, “down”, “upward”, “downward”, “horizontal”, “vertical”, “downflow”, “upflow”, “upstream”, “downstream” and the like do not refer to absolute directions. Instead, these terms refer to directions relative to a nonspecific plane of reference. This non-specific plane of reference may be vertical, horizontal, or other angular orientation.

To facilitate understanding and better appreciation for the described scope, in some instances either identical or similar reference numerals have been used (where possible) to designate identical or similar elements, respectively, that are common in the various Drawings. One of skill in the art may appreciate that elements and features of one embodiment may be beneficially incorporated in one or more other embodiments without further recitation.

### DETAILED DESCRIPTION

In the following disclosure, reference may be made to one or more embodiments. However, one of skill in the art appreciates that the disclosure is not limited to any specifically described embodiment. Rather, any combination of features and elements, whether related to different embodiments or not, is contemplated to implement and practice the one or more embodiments provided by the disclosure. Furthermore, although the one or more embodiments presented in the disclosure may achieve certain advantages over other possible solutions, the prior art (if existing), and combinations thereof, whether or not a particular advantage is achieved by a given embodiment is not limited by this disclosure. The aspects, features, embodiments, and advantages provided are merely illustrative, and do not limit the scope of the disclosure. The aspects, features, embodiments, and advantages provided are not considered elements or limitations of the appended claims except where explicitly recited in one or more of the Claims. Likewise, one of skill in the art should not construe a reference to “the disclosure” as a generalization of any disclosed subject matter.

Aspects of the present disclosure relate to vortex induced vibration (VIV) suppression devices and methods for installing VIV-suppression devices or apparatuses onto tubular members for use in aqueous environments. The VIV-suppression devices or apparatuses may be used with any offshore tubular members, including, but not limited to, pipelines, risers, tension lines, and flowlines.

To prevent substantial fatigue damage to introduced tubular members, especially those portions that are operating in a vertical or near-vertical configurations, VIV-suppression devices are coupled to at least part of the vertical or near vertical tubular member to disrupt the formation of the unstable flow region downflow from the tubular member. Disrupting the formation or maintenance of the unstable formation should reduce the amplitude of the movement and slow the frequency of the vibration of the tubular member. For the purposes of this application, “near-vertical” is defined as having an angular variance from the downward normal of the water surface in a range of about ±20° (degrees) from true vertical.

The VIV-suppression devices, called VIV strakes and fairings, have numerous problems that may contribute to non-productive time (that is, time not laying a tubular member) for the tubular-laying vessel involved and malfunction of the tubular string with the strake or fairings attached. The installation of current VIV-suppression strakes and fairing designs involves affixing the strakes or fairings, which are often configured as units that are one to two feet in linear length, to their desired positions on a tubular member that is to be introduced into the water body while the tubular member is still on a tubular-laying vessel. Additionally, the strakes or fairings are installed one at a time and usually by hand as the strakes or fairings are clamp-like or multicomponent parts that when put end-to-end form a string of strakes or fairings along a portion of the tubular member. The stepwise, manual installation encompasses a significant amount of time of the tubular member introduction, installation, and laydown operation. Adding one or two strakes or fairings at a time to form a series of either along the outside of the tubing member and then proceeding to move the combination off-ship may at times result in significant damage to the strakes or fairings. Hang-off clamp rollers, which are positioned at the end of tubular-laying vessels and help guide lengths of tubular members into the water body, frequently strike and damage strakes or fairings and their attachment clamps as the tubular-laying vessel moves and sways with wave patterns and other surface disruptions.

Therefore, there is a need in the offshore oil and gas extraction industry for improved VIV strake and fairing designs that offer reduced installation time, minimize the amount of manual intervention, and increase the amount of productive time for the tubular-laying vessel.

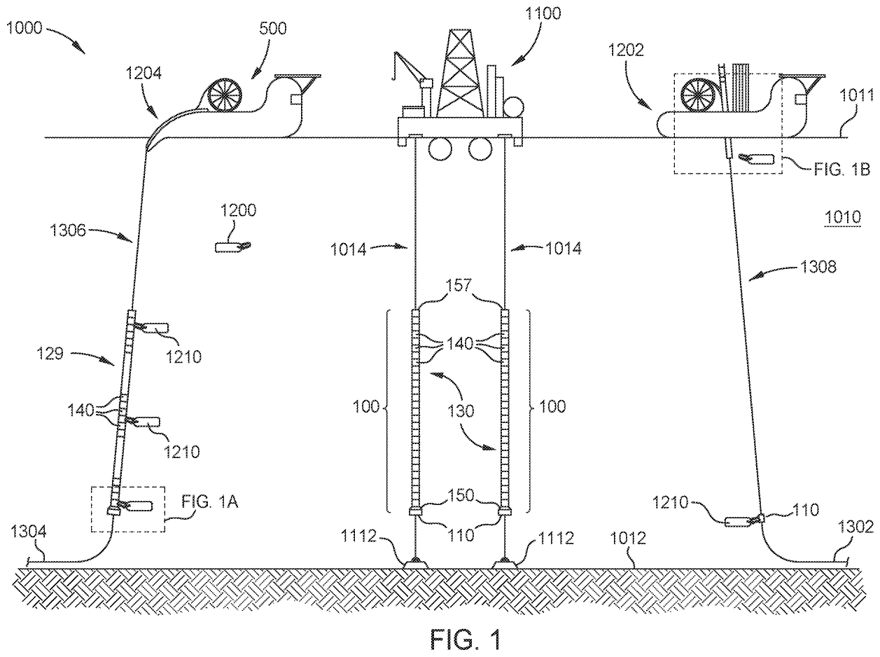

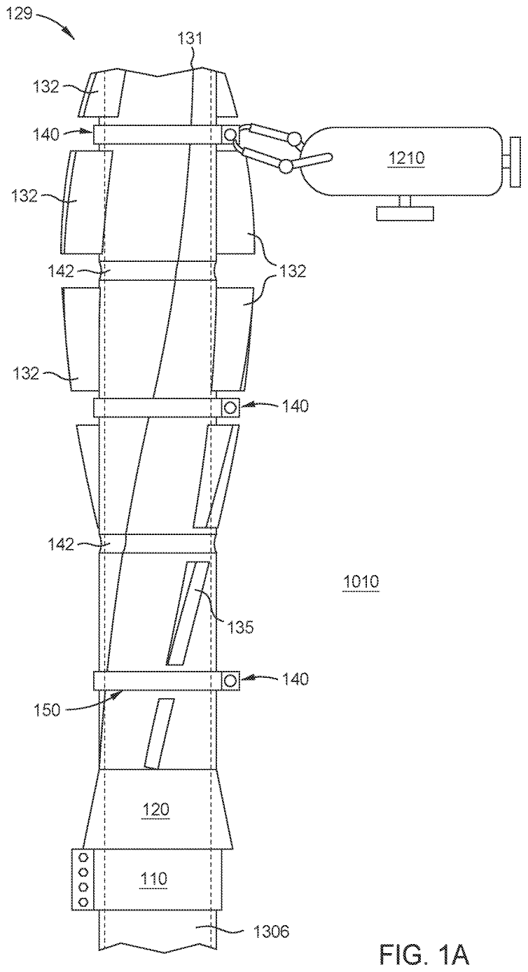

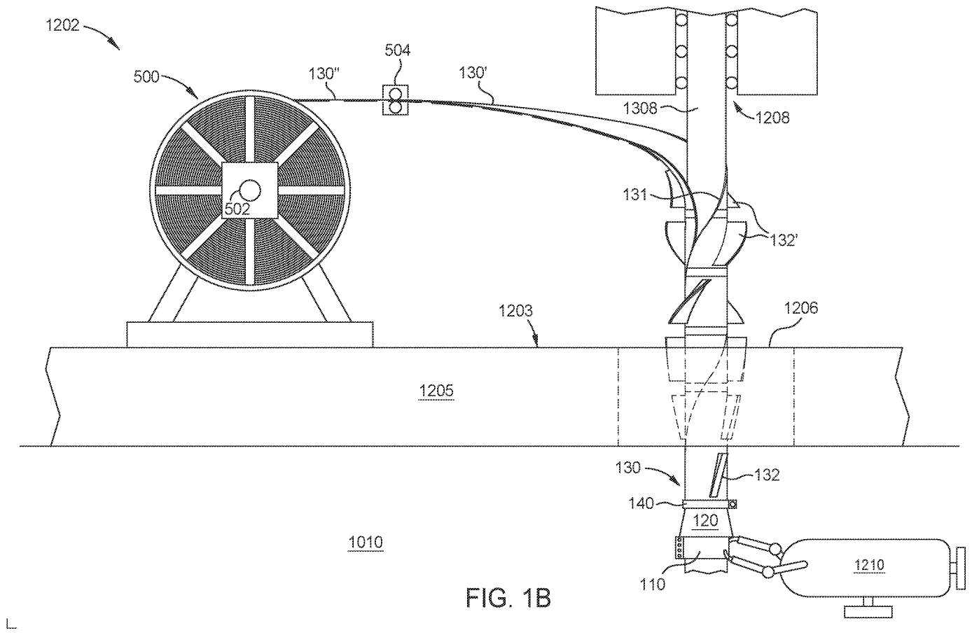

FIG. 1 is a schematic view of a marine environment where one or more embodiment VIV-suppression devices are represented as being or are in the process of being deployed on one or more tubular members. Installation location 1000 includes a body of water 1010 having a water surface 1011 and a bed surface 1012. Offshore production facility 1100 includes offshore facility 1110, which floats on the water surface 1011, is coupled to bed anchors 1112 lying on the bed surface 1012 with tension legs 1014 to keep offshore facility 1110 in a relatively fixed position.

Shown in FIG. 1 and coupled to each tension leg 1014 is a VIV-suppression assembly 100. Each VIV-suppression assembly 100 in this instance is comprised of a lower limit stop clamp 110, a tubular member guide 120, and a VIV-suppression device or apparatus 130, which is coupled to the tension leg 1014 by a plurality of securement bands, rings, or clamps 140. In this instance, only a portion of each tension leg 1014 is covered by the VIV-suppression assembly 100 from a lower part at the lower limit stop clamp 110 to the trailing end 151 of the VIV-suppression device or apparatus 130. Each lower limit stop clamp 110 is positioned along its associated tension leg 1014 upward from its associated bed anchor 1112. The leading end 150 of the VIV-suppression device or apparatus 130 is coupled or connected to the tubular member guide 120 whereas the trailing end 151 of the VIV-suppression device or apparatus 130 is shown uncoupled or unconnected to any other device along the tension leg 1014.

FIG. 1 shows several vessels 1200 located around installation location 1000 performing various activities. Offshore vessel 1202 holds partially suspended in the body of water 1010 a tubular member 1302. This tubular member 1302 may be intended for one or more functions, including conveyance of raw hydrocarbons or partially refined crude oil or gas. The portion of the tubular member 1302 held above the water surface 1011 by offshore vessel 1202 and traversing through the body of water 1010 downward to the bed surface 1012 forms a riser 1308 having a “J” configuration. Offshore vessel 1204 also holds partially suspended in the body of water 1010 a tubular member 1304 where a portion running from the bed surface 1012 to above the water surface 1011 forms an “S” configuration riser 1306.

Although not particular indicated on FIG. 1, the length of the riser is not defined as the length of the tubular member from the bottom of the offshore vessel to the bottom of the body of water. Rather, a “riser length portion” of a tubular member for purposes of this application is the length along the tubular member from the bottom of the offshore vessel to a point where the tubular member, such as tubular members 1302 and 1304, bend towards the horizontal more than the previously defined “near vertical” angle, that is, more than about ±20° from true vertical. Once a tubular member begins bending beyond ±20° from true vertical, the tubular member is transitioning from a vertical angle to the deviated angle regime and further towards the horizontal angle regime. Often proximate to this location is where an external anchor, a lower limit stop clamp, or other stopping device is affixed to prevent a VIV-suppression device or apparatus from sliding further along the tubular member and away from the near vertical portion.

Other offshore vessels 1200 include remote operated vehicles (ROVs) 1210. In FIG. 1, ROVs 1210 are shown performing various activities, including, but not limited to, securing portions of unsecured VIV-suppression device or apparatus 129 to a portion of “S” configuration riser 1306 using clamps 140 (see also insert A; FIG. 1A); inspecting lower limit stop clamp 110 on “J” configuration riser 1308; and supporting the instillation of unsecured VIV-suppression device or apparatus 129 onto “J” configuration riser 1308 (not shown for sake of clarity; see insert B; FIG. 1B).

Each offshore vessel 1202, 1204 also includes a loaded VIV-suppression device spool 500 that wrapped on its one or more VIV-suppression device or apparatus 130. The loaded VIV-suppression device spool 500 is accessible to the portion of the risers 1308, 1306 that is positioned above the water surface 1011 on each offshore vessel 1202, 1204, respectively.

FIG. 1A represents inset “A” of FIG. 1 showing an enhanced schematic view of a marine environment where a portion of an embodiment VIV-suppression device that is not secured is in the process of being deployed on one or more tubular members. A lower portion of a VIV-suppression device or apparatus 130 is shown enveloping “S” configuration riser 1306 with several clamps 140 secured and holding VIV-suppression device or apparatus 130 in position. Lower limit stop clamp 110 and tubular member guide 120 are positioned below the leading end 150 of the VIV-suppression device or apparatus 130. ROV 1210 is shown hovering near one of the clamps 140 as if in the act of securing a clamp 140 into a clamp guide 142 on VIV-suppression device or apparatus 130.

In the enhanced view of FIG. 1A it may be observed that along this embodiment of VIV-suppression device or apparatus 130 there are several fins 132 in a double-helical configuration along the length of the VIV-suppression device or apparatus 130. The configuration is further modified by the several fins 132 being interspaced by the clamp guides 142. In addition, the lengthwise edges 131 of the VIV-suppression device or apparatus 130 meet and form a visible seam that is also helical in configuration along the length of the VIV-suppression device or apparatus 130.

FIG. 1B represents inset “B” of FIG. 1 showing an enhanced schematic view of a marine environment where a portion of an embodiment VIV-suppression device or apparatus that is not secured is in the process of being deployed on one or more tubular members. Offshore vessel 1202 includes vessel hull 1205 having a moon pool 1206 positioned below a portion of pipe handling equipment 1208 through which a portion of “J” configuration riser 1308 is secured above the body of water 1010.

On top of deck 1203, one or more VIV-suppression device or apparatus 130 is wrapped around a loaded VIV-suppression device spool 500 and is positioned proximate to the “J” configuration riser 1308. Loaded VIV-suppression device spool 500 includes a tension brake 502 that keeps back tension on the loaded VIV-suppression device spool 500 and the one or more VIV-suppression device or apparatus 130 until the VIV-suppression device or apparatus 130 passes through tension guide rollers 504. After passing through tension guide rollers 504, a VIV-suppression device or apparatus 130 is no longer under sufficient tension to prevent relaxation of the VIV-suppression device or apparatus 130 at the molecular level, permitting the VIV-suppression device or apparatus 130 post tension guide roller 504 to begin to contract and reshape itself from being “flat packed” into the original sleeve-like form.

During this period of relaxation, the VIV-suppression device or apparatus 130 is applied to the “J” configuration riser 1308 held in position by the pipe handling equipment 1208 such that the VIV-suppression device or apparatus 130 at least partially envelopes to the “J” configuration riser 1308. As shown in FIG. 1B proximate to the surface of the deck 1203 and below the pipe handling equipment 1208, one of the lengthwise edges 131 of the VIV-suppression device or apparatus 130 is visible wrapped around the “J” configuration riser 1308 and the fins are partially-unfolded 132′ as the fins expands away from the outer surface of the VIV-suppression device or apparatus 130.

Also shown in FIG. 1B is an ROV 1210 coupled with and applying downward directional force to a tubular member guide 120. The tubular member guide 120 is connected via clamp 140 to a leading end (not shown for clarity) of the VIV-suppression device or apparatus 130. As the ROV 1210 applies a sufficient downward force (arrow) to overcome the back tension on the loaded VIV-suppression device spool 502, the expanded/“flat packed” VIV-suppression device or apparatus 130″ is drawn from loaded VIV-suppression device spool 500 (arrow), through the tension guide roller 504 (arrow), and around a portion of the suspended “J” configuration riser 1308 that is on the deck 1203 of offshore vessel 1202. The transitioning portion of the VIV-suppression device or apparatus 130′ relaxes, traverses downward and continues to relax and contract around the “J” configuration riser 1308 while being drawn through the moon pool 1206 by the ROV 1210 that is coupled to and is moving the VIV-suppression device or apparatus 130 downward (arrow) into the water body 1010. During this transition period, the previously-flattened fins 132″ (not shown for clarity) unfold (unfolding fins 132′) until fully relaxed and directed outwards (fins 132).

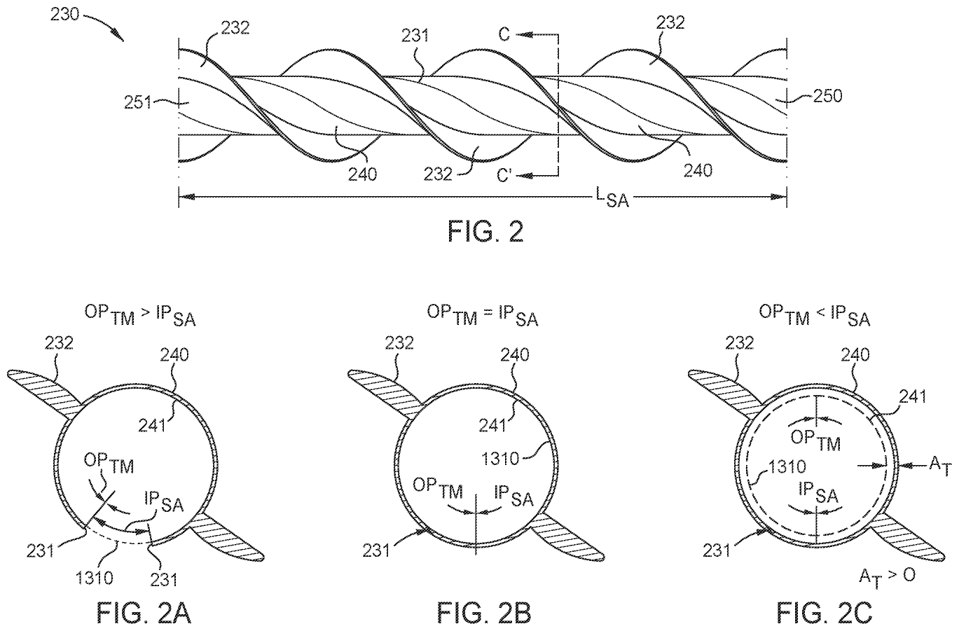

FIG. 2 is a schematic of a VIV-suppression device in a sleeve-like strake configuration. The VIV-suppression device or apparatus 230 of FIG. 2 is shown in a double-helix strake configurations from a side view as would be deployed and before securing to a tubular member. In some instances, the VIV-suppression device or apparatus 130 shown in FIG. 1 may be of a similar configuration. VIV-suppression device or apparatus 230 is shown having a length “L(SA)” (length-suppression apparatus). Along the length L(SA) may also be observed a seam formed by the meeting of the lengthwise edges 231 of the VIV-suppression device 230. As well, two separate fins 232 having an eel-like continuous configuration are incorporated onto or as part of the outer surface 240 parallel to the helical pattern of the seam. At one end of the length L(SA) for the VIV-suppression device or apparatus 230 is a leading end 250; at the other end is the trailing end 251, which is similar to the trailing end 151 of FIG. 1.

In one or more embodiments, the material of construction of the VIV-suppression device or apparatus is an elastic polymer material. In one or more embodiments, the elastic polymer material of the VIV-suppression device or apparatus is comprised of a natural or synthetic elastic rubbers. Non-limiting examples of natural or synthetic elastic rubbers include natural rubbers, butadiene rubbers, styrene-butadiene rubbers, neoprenes, polysulfide rubbers (thiokols), butyl rubbers, silicones, and combinations thereof. Elastic polymer materials have several advantages not only in configuration of the VIV-suppression device or apparatus but also in application to a tubular member in a body of water, as will be discussed further forthcoming.

An embodiment VIV-suppression device or apparatus is a continuous, unitary member having a length L(SA). That is, for any given embodiment of a VIV-suppression device or apparatus, there is no separation or break normal to a lengthwise axis for a given L(SA). In one or more embodiments, which may be combined with other embodiments, the length of a VIV-suppression device or apparatus is in the range of from about 12 meters (m) to about 6,0000 m, such as, but not limited to, about 12, 24, 36, 48, 60, 72, 90, 100, 110, 120, 130, 140, 150, 160, 170, 180, 190, 200, 250, 300, 350, 400, 500, 600, 700, 800, 900, 1,000, 1,100, 1,200, 1,300, 1,400, 1,500, 1,600, 1,700, 1,800, 1,900, 2,000, 3,000, 4,000, 5,000, and 6,000 meters, including all values, such as including end points, and range combinations thereof.

Although a VIV-suppression apparatus may have a length L(SA), one of ordinary skill appreciates that this fact does not foreclose that a plurality of VIV-suppression devices or apparatuses may be applied on the same portion of a tubular member, where each VIV-suppression device or apparatus either has the same length or different lengths, and combined to form an extended length of VIV-suppression device or apparatus. The VIV-suppression devices or apparatuses may be positioned such that a trailing end of a first device is in contact with the leading end of a second device. Or, each device may be separated along the same riser by a distance of unprotected riser.

As shown on FIG. 1, the VIV-suppression device or apparatus does not have to cover the entire length of a given riser portion of a tubular member to abate or mitigate vortex-induced inflections of the tubular member. In one or more embodiments, which may be combined with other embodiments, the percentage length of a riser enveloped by a VIV-suppression device or apparatus is in the range of from about 0.1 percent (%) to about 35% of the riser length, such as, but not limited to, about 0.1, 0.5, 1, 2, 3, 5, 10, 15, 20, 25, 30, and 35% of the riser length, including all values, such as including end points, and range combinations thereof.

FIGS. 2A-C each show a reveal cross section view along view lines C-C′ for the VIV-suppression device or apparatus of FIG. 2. FIG. 2A shows a VIV-suppression device cross section view where the inner circumference or perimeter of the suppression apparatus IP(SA) is less than the outer perimeter of the tubular member OP(TM). FIG. 2B shows a VIV-suppression device cross section view where the inner circumference or perimeter of the suppression apparatus is equivalent to the outer perimeter of the tubular member. FIG. 2C shows a VIV-suppression device cross section view where the inner circumference or perimeter of the suppression apparatus is greater than the outer perimeter of the tubular member.

FIGS. 2A-C each show through the cross-sectional view that the VIV-suppression device or apparatus 230 has both an exterior surface 240, an interior surface 241, lengthwise edges 231, and helically-configured fins 232.

The VIV-suppression device or apparatus along its length L(SA) has a diameter, a diagonal, or other measurement of interior width that provides the distance between opposing points along the interior surface. Because tubular members to which a VIV-suppression device or apparatus may be applied to may have both different external configurations (for example, cylindrical, prismatic) and be of different sizes (for example, 6:, 12″, 18″, 24″, 36″, and 48″ diameter pipe), embodiment VIV-suppression devices or apparatuses may be differentiated not only by length L(SA) but also by using a common measurement for the interior surface, such as the inner circumference or perimeter of the suppression apparatus IP(SA). In one or more embodiments, which may be combined with other embodiments, the inner perimeter of a VIV-suppression device or apparatus is in the range of from about 33 centimeters (cm) to about 500 cm, such as, but not limited to, about 33, 33.5, 47.9, 62.2, 67.0, 95.8, 100.5, 124.5, 134.1, 143.6, 186.7, 191.5, 201.1, 249.0, 268.1, 287.3, 373.4, 383.0, 497.9, and 500 cm, including all values, such as including end points, and range combinations thereof.

As suggested by the descriptions of FIGS. 2A-C, in some instances the VIV-suppression device or apparatus applied to a tubular member, such as representative cylindrical tubular member 1310 (dashed where shown), the inner perimeter of the suppression apparatus is not equivalent to the outer permitted of the tubular member, such as represented in FIG. 2B. In some instances, the inner perimeter of the suppression apparatus is less than the outer permitted of the tubular member, such as represented in FIG. 2A. In FIG. 2A, the lengthwise edges 231 are visibly separated from one another and a portion of the outer surface of representative cylindrical tubular member 1310 is exposed to the external environment. In some other instances, the inner perimeter of the suppression apparatus is greater than the outer permitted of the tubular member, such as represented in FIG. 2C. In FIG. 2C, just as in FIG. 2B, the lengthwise edges 231 meet and form a lengthwise seam. In between interior surface 241 of the VIV-suppression device or apparatus 230 and the exterior surface of the representative cylindrical tubular member 1310 there is an annular thickness A(T) representing an annular void.

In one or more embodiments, which may be combined with other embodiments, the inner perimeter of a VIV-suppression device or apparatus is in the range of from about 70 percent (%) to about 130% of the outer perimeter of an associated tubular member, such as, but not limited to, about 70, 75, 80, 85, 90, 95, 100, 105, 110, 115, 120, 125, and 130% of the outer perimeter of the tubular member, including all values, such as including end points, and range combinations thereof.

An embodiment VIV-suppression device or apparatus may be moved with greater ease in an aqueous environment in instances where an annular void is defined between the exterior surface of a tubular member and the interior surface an embodiment VIV-suppression device or apparatus. In moving an instance of a VIV-suppression device or apparatus upwards or downwards (in some cases “up pipe” and “down pipe”), the dense fluid environment may provide a lubrication effect that assists in allowing the VIV-suppression device or apparatus to slide across the outer surface of the tubular member. The potential buoyancy effect (or lack thereof) based upon the materials of construction of the VIV-suppression device or apparatus may assist in freedom-of-movement of the outer and inner surfaces from contacting one another. The differences in diameters, diagonals, or operational widths of the tubular member and the VIV-suppression device or apparatus also may permit the VIV-suppression device or apparatus to more easily pass over defects, sharp bends, tool joints, welds, and other potential obstructions to a sliding movement against the exterior surface of the tubular member as the VIV-suppression device or apparatus is being traversed to its operational position. As well, the difference in diameters, diagonals, or operational widths should also permit the aqueous fluid to more freely move into, out of, and through the annular void, enhancing the lubrication effect.

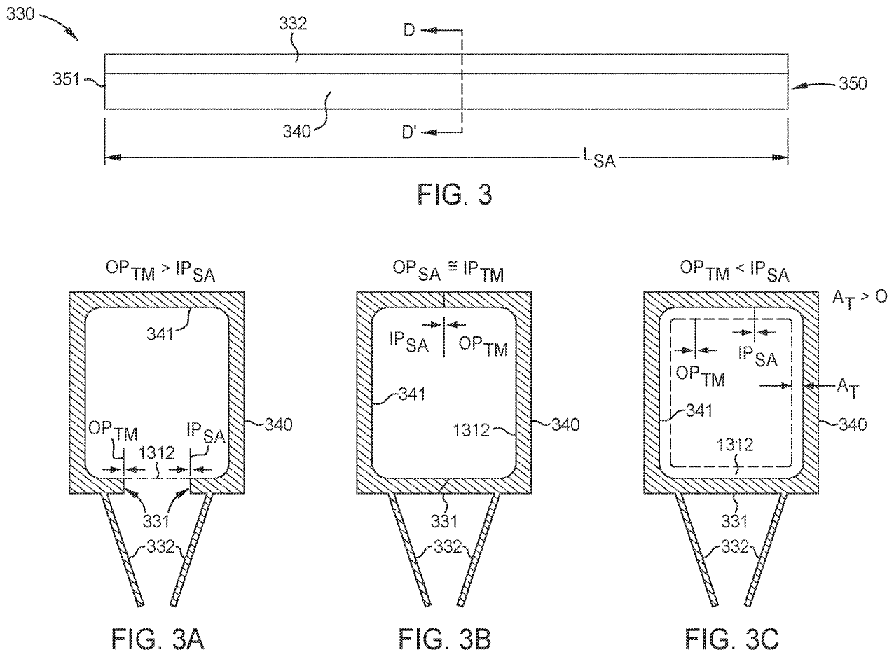

FIG. 3 is a schematic of a VIV-suppression device in a sleeve-like fairing configuration. VIV-suppression device or apparatus 330 of FIG. 3 has many of the same attributes as VIV-suppression device or apparatus 230 of FIG. 2. Notable differences between the strake variant and the fairing variant of embodiment VIV-suppression device or apparatus includes that strakes tend to utilize helical forms, including the configuration of the one or more fins along the length of the device or apparatus. Fairings tend to use one or more trailing fins, such as trailing fins 332, which are positioned on the downflow or “back side” of the system to abate or mitigate the formation of vortices. As well, the lengthwise edges, such as lengthwise edges 331 (not shown in FIG. 3) are usually not patterned such that would cause breaks in the trailing fins 332, such as in a helical pattern along the length, although this disclosure does not teach away from such a configuration.

FIGS. 3A-C each show a reveal cross section view along view lines D-D′ for the VIV-suppression device or apparatus of FIG. 3 in a manner similar to FIGS. 2A-C. FIG. 3A shows a VIV-suppression device cross section view where the inner perimeter of the suppression apparatus IP(SA) is less than the outer perimeter of the tubular member OP(TM). FIG. 3B shows a VIV-suppression device cross section view where the inner perimeter of the suppression apparatus is equivalent to the outer perimeter of the tubular member. FIG. 3C shows a VIV-suppression device cross section view where the inner perimeter of the suppression apparatus is greater than the outer perimeter of the tubular member. Embodiments of VIV-suppression device or apparatus 330 are shown relative to a representative rectangular prism tubular member 1312 to show that embodiment VIV-suppression devices or apparatuses may be configured to form around and envelop non-traditionally shaped tubular members should such requirements be presented.

As shown in the “B” inset of FIG. 1 and more specifically in FIG. 1B, the loaded VIV-suppression device spool 500 may include one or more length of VIV-suppression device or apparatus in an extended state. In one or more embodiments, which may be combined with other embodiment, a loaded VIV-suppression device spool containing one or more lengths of VIV-suppression device or apparatus as shown in FIGS. 1 and 1B may be mounted on a transport vessel, such as a truck bed, a tubular-laying offshore vessel, or a floating rig. In one or more embodiments, which may be combined with other embodiments, a loaded VIV-suppression device spool containing one or more lengths of VIV-suppression device or apparatus is be mounted to a fixed structure, such as an offshore rig, like a jack up. The spool itself may be “mounted” or positioned on a fixed or mobile platform permanently or temporarily, that is, the spool may be removable (temporary) or part of the structure (permanent). As shown in FIG. 1B and previously described, an embodiment VIV-suppression device or apparatus 130 is being unwound from loaded VIV-suppression device spool 500 and introduced onto the portion of the “J” configuration riser 1308 above the water surface 1011 in the process of fabricating an embodiment VIV-suppression assembly 100.

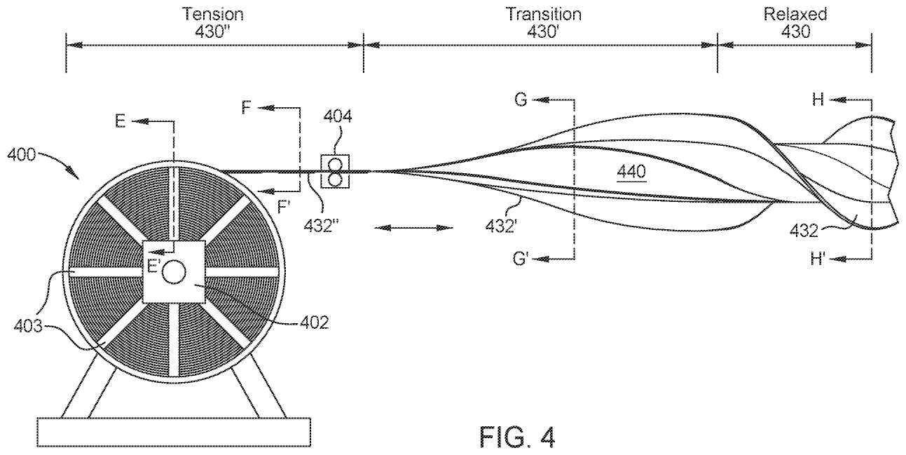

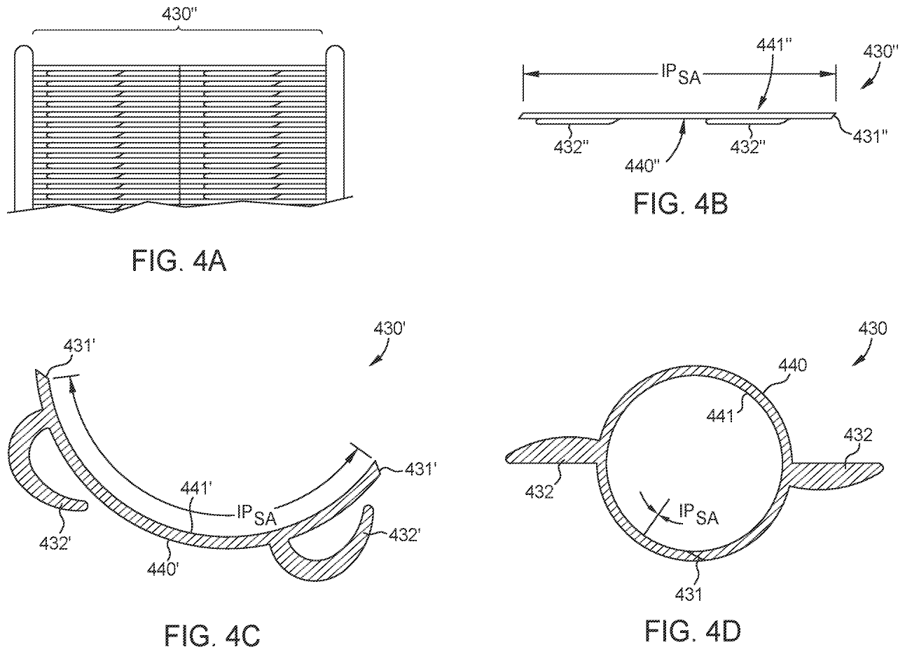

FIG. 4 is a schematic representation of an embodiment VIV-suppression device in different phases of configuration transition between a fully relaxed and contracted state and an under tension, expanded, and wrapped onto a loaded VIV-suppression device spool. Loaded VIV-suppression device spool 400, which is similar to loaded VIV-suppression device spool 500 of FIGS. 1 and 1B, is shown from a side view having a spool hub 402, several spool spokes 403, and fully loaded with one or more lengths of a VIV-suppression device or apparatus under tension 430″.

In one or more embodiments, which may be combined with other embodiments, a loaded VIV-suppression device spool comprises one or more vortex-induced vibration (VIV)-suppression device or apparatus having a unitary length in a range of from 12 meters (m) to 6,000 meters wrapped around a hub of the spool in an extended, ribbon-like configuration under tension and comprised of an elastic polymeric material.

FIG. 4 may be representative of states of configuration for embodiment VIV-suppression device or apparatus either or both during wrapping a VIV-suppression device or apparatus onto a spool or unwrapping a VIV-suppression device or apparatus from a spool (double-headed arrow). For the sake of clarity, the description relative to FIG. 4 and FIGS. 4A-D are not intended to be limiting with regards to either the loading or unloading of either an embodiment VIV-suppression device spool or an embodiment VIV-suppression device or apparatus.

In one or more embodiments, which may be combined with other embodiments, the loaded VIV-suppression device spool is mounted on an offshore vessel. In one or more embodiments, which may be combined with other embodiments, the VIV-suppression device or apparatus has a strake configuration. In one or more embodiments, which may be combined with other embodiments, the VIV-suppression device or apparatus has a fairing configuration.

Similar to FIG. 1B, one or more VIV-suppression devices or apparatuses in FIG. 4 are associated with the loaded VIV-suppression device spool, and the one or more VIV-suppression devices or apparatuses are shown in several states of configuration. Both on loaded VIV-suppression device spool 400 and in between the tension guide rollers 404, the one or more VIV-suppression devices or apparatuses are represented to be under tension 430″. FIG. 4A is a schematic representing a partial cut-away view of a loaded VIV-suppression device spool. As shown in FIG. 4A, several windings of VIV-suppression device or apparatus under tension 430″ are shown around spool hub 402 and in between spool spokes 403. The several windings of VIV-suppression device or apparatus under tension 430″ are in a “flat packed” or ribbon-like wound configuration while on loaded VIV-suppression device spool 400. The lengthwise edges (not numbed for the sake of clarity) of each VIV-suppression device or apparatus are spread as widely apart as possible; adjacent lengthwise edges may be in contact with a spool spokes 403, as shown. The fins 432″ for each VIV-suppression device or apparatus under tension 430″ are elastically folded underneath and in between layers VIV-suppression device or apparatus under tension 430″.

In one or more embodiments, the elastic polymer material of the VIV-suppression device or apparatus is a natural or synthetic elastic rubbers. In one or more embodiments, the material of construction of the VIV-suppression device or apparatus is an elastic polymer material. Non-limiting examples of natural or synthetic elastic rubbers include natural rubbers, butadiene rubbers, styrene-butadiene rubbers, neoprenes, polysulfide rubbers (thiokols), butyl rubbers, silicones, and combinations thereof.

As previously indicated, given the length (L(SA)) of one or more VIV-suppression device or apparatus, in one or more embodiments a loaded VIV-suppression device spool may comprise one VIV-suppression device or apparatus under tension. In using a spool loaded with only one VIV-suppression device or apparatus under tension, it is envisioned that if a length of VIV-suppression device or apparatus is to be used in a method of installation that is less than the length of the VIV-suppression device or apparatus under tension on the spool that an appropriate length may be drawn from the loaded spool and then at the appropriate position along the VIV-suppression device or apparatus a trailing end formed by cutting or severing the VIV-suppression device or apparatus. The remaining VIV-suppression device or apparatus material drawn but not used may then be reloaded onto to now partially-loaded spool by placing the material back under a sufficient amount of tension and rewinding the material onto the spool to partially reform the “flat packed” or ribbon-like wound configuration while under tension on the spool given the elastic nature of the VIV-suppression device or apparatus.

In one or more embodiments, which may be combined with other embodiments, the inner perimeter of a VIV-suppression device or apparatus is in the range of from about 33 centimeters (cm) to about 500 cm, such as, but not limited to, about 33, 33.5, 47.9, 62.2, 67.0, 95.8, 100.5, 124.5, 134.1, 143.6, 186.7, 191.5, 201.1, 249.0, 268.1, 287.3, 373.4, 383.0, 497.9, and 500 cm.

As previously described, in embodiment configurations of a VIV-suppression device or apparatus where the VIV-suppression device or apparatus is comprised of an elastic polymer material, the VIV-suppression device or apparatus as formed may be temporarily deformed when placed under a degree of tension. The minimum degree of tension required to cause sufficient deformation of the VIV-suppression device or apparatus to permit the VIV-suppression device or apparatus to fully reach an expanded or non-relaxed state will depend on variables, including, but not limited to, the material composition, the thickness of the body, and the rigidity at the point of joinder between the body and the fins of the VIV-suppression device or apparatus, that are different between any different VIV-suppression device or apparatus. A sufficient degree of tension, which would include and be greater than the minimum degree of tension required but not greater than an amount of tension that would cause permanent plastic deformation or destruction of the component parts of the unitary VIV-suppression device or apparatus, would likely need an amount of empirical determination before loading a given VIV-suppression device or apparatus onto a given VIV-suppression device spool.

FIG. 4B is a schematic representing a cross section view of a VIV-suppression device under tension. As shown along view lines F-F′ of FIG. 4, VIV-suppression device or apparatus under tension 430″ is no longer “flat packed” onto loaded VIV-suppression device spool 400 but is still under sufficient tension in between the spool 400 and the tension guide rollers 404 to have the ribbon-like or expanded configuration. As may be seen in FIG. 4B, the interior surface 441″ is flattened and directed in an upward-facing direction; the exterior surface 440″ is flattened and directed in a downward-facing direction; lengthwise edges 431″ are separated from one another by the full interior perimeter distance for the suppression apparatus IP(SA) because of the under-tension configuration. As shown before in FIG. 4A, the fins 432″ are also shown still folded under the exterior surface 440.

FIG. 4C is a schematic representing a cross section view of a VIV-suppression device under transition between a state of tension and a state of relaxation. As shown along view lines G-G′ of FIG. 4, VIV-suppression device or apparatus is shown in a state of transition 430′. For example, lengthwise edges 431′ are shown closer to one another than the length IP(SA) as was shown in FIG. 4B due to the curvature of interior surface 441′. As well, the fins 432′ are also shown in a partially-deployed or in a transitional state as exterior surface 440′ bows outward. This may be interpreted as either the VIV-suppression device or apparatus that was previously under tension relaxing or a VIV-suppression device or apparatus having tension applied to transition into the “flat packed” configuration.

During a state of transition, especially when a VIV-suppression device or apparatus being drawn from an VIV-suppression device spool, is when in one or more embodiments the VIV-suppression device or apparatus may be applied to the surface of a tubular member such that the VIV-suppression device or apparatus envelopes around at least part of the exterior surface of the tubular member.

FIG. 4D is a schematic representing a cross section view of a VIV-suppression device under relaxation. As shown along view lines H-H′ of FIG. 4, VIV-suppression device or apparatus is shown in a state of relaxation or contraction. One viewing the apparatus shown in FIG. 4D may see that this is a cross-sectional view of an embodiment VIV-suppression device or apparatus, such as VIV-suppression device or apparatus 430, as already deployed around a tubular member or as having been manufactured, and similar to embodiment VIV-suppression devices or apparatuses of FIGS. 3A-C and FIG. 4-C and as provided in the descriptions thereof.

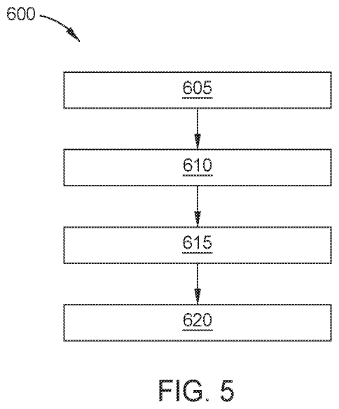

FIG. 5 shows a process flow diagram for a method of installing a VIV-suppression assembly. In one or more embodiments, which may be combined with other embodiments, a method or process 600 of FIG. 5 includes introducing a vortex-induced vibration (VIV) suppression device or apparatus to a tubular member above a surface of a body of water, where a portion of the tubular member is suspended above the surface of the body of water and where a riser length potion of the tubular member is suspended in a vertical or near-vertical configuration below the surface of the water 605. The introduction occurs such that the VIV-suppression device or apparatus at least partially envelopes the tubular member and forms an unsecured VIV-suppression device or apparatus around the tubular member.

In one or more embodiments, which may be combined with other embodiments, the VIV-suppression device or apparatus is introduced from a loaded VIV-suppression device spool, where the spool comprises one or more VIV-suppression device or apparatus in a “flat packed” or ribbon-like wound configuration.

In one or more embodiments, which may be combined with other embodiments, the VIV-suppression device or apparatus has a strake configuration. In one or more embodiments, which may be combined with other embodiments, the VIV-suppression device or apparatus has a fairing configuration.

In one or more embodiments, which may be combined with other embodiments, the VIV-suppression device or apparatus is a unitary piece having a length L(SA) in a range of from about 12 meters (m) to 6,000 m. As previously described, a longer length of VIV-suppression device or apparatus may be trimmed or cut to a shorter length to apply appropriate coverage to the riser to which the VIV-suppression device or apparatus is applied.

In one or more embodiments, which may be combined with other embodiments, an inner perimeter of the unsecured VIV-suppression device or apparatus is in the range of from about 70 percent (%) to about 130% of an outer perimeter of the tubular member.

In one or more embodiments, which may be combined with other embodiments, a method or process 600 of FIG. 5 includes introducing the unsecured VIV-suppression device or apparatus around the tubular member into the body of water 610. The introduction of the unsecured VIV-suppression device or apparatus into the body of water may be done by “pushing” the VIV-suppression device or apparatus into the body of water from above the surface of the body of water, such as through a feeding device that both pulls from a VIV-suppression device or apparatus and pushes the VIV-suppression device or apparatus transitioning from under tension into a relaxed state onto and around the tubular member. The introduction of the unsecured VIV-suppression device or apparatus into the body of water may also be done by “pulling” the VIV-suppression device or apparatus or another apparatus to which the unsecured VIV-suppression device or apparatus is coupled or connected to, such as tubular member guide 120 as shown in FIG. 1B, into the body of water from below the surface, such as being guided by an ROV operating in the body of water.

In one or more embodiments, which may be combined with other embodiments, a method or process 600 of FIG. 5 includes positioning the unsecured VIV-suppression device or apparatus along the riser length of the tubular member 615. In one or more embodiments, the unsecured VIV-suppression device or apparatus is positioned such that the leading end of the VIV-suppression device or apparatus is located proximate to a lower limit stop clamp secured to the tubular member along the riser length. As shown in FIG. 1A, leading end 150 of the unsecured VIV-suppression device or apparatus 129 is positioned proximate to the lower limit stop clamp 110 along the length of the “J” configuration riser 1308.

In one or more embodiments, which may be combined with other embodiments, where the VIV-suppression device or apparatus has a length that is in the range of from about 0.1 percent (%) to about 35% of the riser length.

In one or more embodiments, which may be combined with other embodiments, a method or process 600 of FIG. 5 includes securing the unsecured VIV-suppression device or apparatus along the riser length of the tubular member such that at least a portion of the inner perimeter of the secured VIV-suppression device or apparatus contacts the outer perimeter of the tubular member, forming the VIV-suppression assembly. In one or more embodiments, the VIV-suppression device or apparatus is secured to the tubular member utilizing one or more securement bands, rings, or clamps comprised of Inconel. Other materials and methods of securing the VIV-suppression device or apparatus is secured to the tubular member are envisioned.

While the various steps in an embodiment method or process are presented and described sequentially, one of ordinary skill in the art will appreciate that some or all of the steps may be executed in different order, may be combined or omitted, and some or all of the steps may be executed in parallel. The steps may be performed actively or passively. The method or process may be repeated or expanded to support multiple components or multiple users within a field environment. Accordingly, the scope should not be considered limited to the specific arrangement of steps shown in a flowchart or diagram.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise. Within a claim, reference to an element in the singular is not intended to mean “one and only one” unless specifically so stated, but rather “one or more.” Unless specifically stated otherwise, the term “some” refers to one or more.

Embodiments of the present disclosure may suitably “comprise”, “consist” or “consist essentially of” the limiting features disclosed, and may be practiced in the absence of a limiting feature not disclosed. As used here and in the appended claims, the words “comprise,” “has,” and “include” and all grammatical variations thereof are each intended to have an open, non-limiting meaning that does not exclude additional elements or steps.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

As used, terms such as “first” and “second” are arbitrarily assigned and are merely intended to differentiate between two or more components of a system, an apparatus, or a composition. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is contemplated under the scope of the various embodiments described.

Although only a few example embodiments have been described in detail, those skilled in the art will readily appreciate that many modifications are possible in the example embodiments without materially departing from the disclosed scope as described. Accordingly, all such modifications are intended to be included within the scope of this disclosure as defined in the following claims. In the claims, means-plus-function clauses are intended to cover the structures described as performing the recited function and not only structural equivalents, but also equivalent structures. For example, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f), for any limitations of any of the claims, except for those in which the claim expressly uses the words ‘means for’ together with an associated function.

The following claims are not intended to be limited to the embodiments provided but rather are to be accorded the full scope consistent with the language of the claims.

1. A method for installing a vortex-induced vibration (VIV)-suppression assembly, comprising:
introducing a vortex-induced vibration (VIV)-suppression device to a tubular member above a surface of a body of water such that the tubular member is at least partially enveloped, where a portion of the tubular member is suspended above the surface of the body of water and where a riser length potion of the tubular member is suspended below the surface of the water in a vertical or near-vertical configuration;
introducing the VIV-suppression device around the tubular member into the body of water;
positioning the VIV-suppression device along the riser length of the tubular member; and
securing the VIV-suppression device along the riser length of the tubular member such that at least a portion of an inner perimeter of the secured VIV-suppression device contacts an outer perimeter of the tubular member, forming a VIV-suppression assembly.

2. The method of claim 1, where the VIV-suppression device has a strake configuration.

3. The method of claim 1, where the VIV-suppression device is introduced to the tubular member from a loaded VIV-suppression device spool.

4. The method of claim 3, where the loaded VIV-suppression device spool comprises one or more VIV-suppression device having a unitary length in a range of from 12 meters (m) to 6,000 meters wrapped around a hub of the spool in an extended, ribbon-like configuration under tension and comprised of an elastic polymeric material.

5. The method of claim 3, where the loaded VIV-suppression device spool is mounted on an offshore vessel.

6. The method of claim 1, where the VIV-suppression device introduced to the tubular member is a unitary piece having a length in a range of from about 12 m to 6,000 m.

7. The method of claim 1, where the VIV-suppression device is comprised of an elastic polymeric material.

8. The method of claim 7, where the elastic polymer material is selected from the group consisting of natural rubbers, butadiene rubbers, styrene-butadiene rubbers, neoprenes, polysulfide rubbers (thiokols), butyl rubbers, silicones, and combinations thereof.

9. The method of claim 1, where the inner perimeter of the VIV-suppression device has a range of from about 70 percent (%) to about 130% of the outer perimeter of the tubular member.

10. The method of claim 1, where the VIV-suppression device is positioned such that a leading end of the VIV-suppression device is located proximate to a lower limit stop clamp secured to the tubular member along the riser length potion of the tubular member.

11. The method of claim 1, where the VIV-suppression device has a length that is in a range of from about 0.1 percent (%) to about 35% of the riser length potion of the tubular member.

12. The method of claim 1, where the VIV-suppression device is secured along the riser length potion of the tubular member utilizing one or more securement bands, rings, or clamps comprised of Inconel.

13. The method of claim 7, where the elastic polymeric material comprises natural or synthetic elastic rubbers.

14. A loaded VIV-suppression device spool, comprising one or more vortex-induced vibration (VIV)-suppression device having a unitary length in a range of from 12 meters (m) to 6,000 meters wrapped around a hub of the spool in an extended, ribbon-like configuration under tension and comprised of an elastic polymeric material.

15. The loaded VIV-suppression device spool of claim 14, where the loaded VIV-suppression device spool is mounted on an offshore vessel.

16. The loaded VIV-suppression device spool of claim 14, where the VIV-suppression device has a strake configuration.

17. The loaded VIV-suppression device spool of claim 14, where the elastic polymer material is selected from the group consisting of natural rubber, butadiene rubbers, styrene-butadiene rubbers, neoprenes, polysulfide rubbers (thiokols), butyl rubbers, silicones, and combinations thereof.

18. The loaded VIV-suppression device spool of claim 14, where the VIV-suppression device has an inner perimeter in the range of from about 33 centimeters (cm) to about 500 cm.
